(19) United States
(12) Patent Application Publication
(10) Pub. No.: US 2016/0008199 A1
(43) Pub. Date: Jan. 14, 2016

(54) POSITION DEVICE FOR PERCUTANEOUS INTERVENTION

(71) Applicant: Roberto Neri, Bracciano (IT)

(72) Inventor: Roberto Neri, Bracciano (IT)

(21) Appl. No.: 14/525,977

(22) Filed: Oct. 28, 2014

(30) Foreign Application Priority Data
Jul. 9, 2014 (IT) RM2014A000370

(51) Int. Cl. A61G 13/00

(52) U.S. Cl. CPC A61G 13/0036; A61G 2013/0045

(57) ABSTRACT

A positioning device includes a support element and a spacer element that connects the support element to a base member. The support element has a support member for the arm and is shaped to hold an arm of a patient in a desired position during a percutaneous interventional procedure. The spacer element includes an adjustment mechanism that adjusts the relative position and orientation of the support element with respect to the base member

### RELATED APPLICATION

This application claims priority to Italy Patent Application No. RM2014A000370, filed on Jul. 9, 2014, the entire contents of which are incorporated herein by reference.

### FIELD

The present disclosure relates to a medical device. More specifically, the present disclosure relates to a device for positioning an upper limb of a patient to allow percutaneous interventional procedures performed through the radial vascular access.

### BACKGROUND

The statements in this section merely provide background information related to the present disclosure and may or may not constitute prior art.

In recent years percutaneous interventions have shown an exponential growth in number as well as complexity of the procedures performed. During these procedures, the patient typically maintains body positions to comply with the needs of the operation being performed. These positions may significantly decrease the comfort of the patient and at the same time the physician's ability to precisely manipulate the medical devices employed for the procedure. The difficulties encountered are generally greater in certain percutaneous vascular accesses (for example, access through the left arm). As such, these accesses are underused, even though they may be beneficial for the success of the procedure.

Many physicians perform vascular access from the upper limbs with the arm abducted (that is, the arm is positioned far from the body of the patient). The abducted arm makes the vascular access easier especially for right handed physicians performing a left arm access. After the vascular access is completed, however, the arm has to be repositioned close to the patient body to perform the interventional procedure. The currently available devices are intended to be used with a large number of patients and are not designed to be adapted to the specific needs of the patients and of the physicians.

### SUMMARY

Accordingly, there is a need for a device to position and support an arm of a patient on a surface of a base member with an orientation to allow the execution of vascular access during a percutaneous interventional procedure.

In one aspect, the device includes a support element and a spacer element that connects the support element to the base member. The support element has a support member for the arm and is shaped to hold the arm in the desired position during the procedure. The spacer element includes an adjustment mechanism that adjusts the relative position and orientation of the support element with respect to the base member.

The device may provide one or more of the following advantages. The device allows the physician to position the patient's arm in desired orientation while the patient is able to maintain this orientation comfortably. The device enables positioning the patient's arm to allow bilateral vascular access. The device is also adjustable in multiple directions to accommodate the specific anatomical features of the patients.

Further features, advantages, and areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, emphasis instead being placed upon illustrating the principles of the invention. Moreover, in the figures, like reference numerals designate corresponding parts throughout the views. In the drawings:

FIG. 1 is a perspective view of a positioning device in accordance with the principles of the present invention;

FIG. 2 is a close-up perspective view of the positioning device;

FIG. 3 is a perspective view of another positioning device in accordance with the principles of the present invention;

FIG. 4 is an exploded view of the positioning device shown in FIGS. 1 and 2;

FIG. 5 is perspective view of yet another position device in accordance with the principles of the present invention; and

FIG. 6 is a close-up view of the positioning device shown in FIG. 5.

### DETAILED DESCRIPTION

The following description is merely exemplary in nature and is not intended to limit the present disclosure, application, or uses.

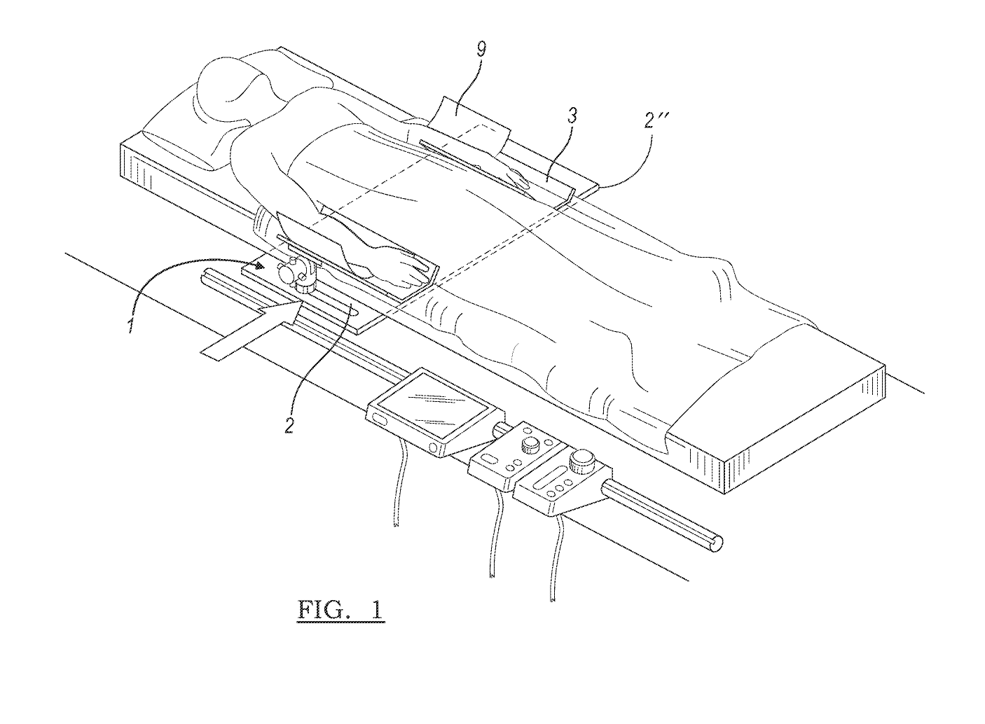

Referring now to the drawings, a positioning device embodying the principles of the present invention is illustrated in FIG. 1 and designated at 1. The positioning device 1 positions and supports a patient's forearm on a surface of a base member 2, with an orientation that allows vascular access of the patient procedures during percutaneous interventions.

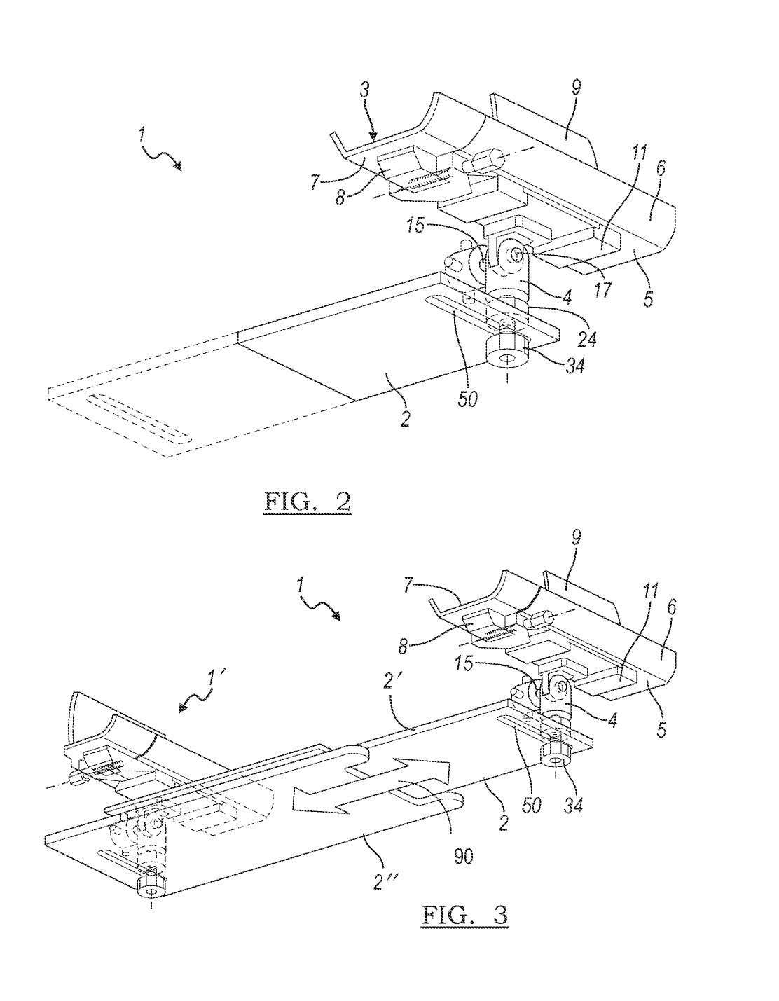

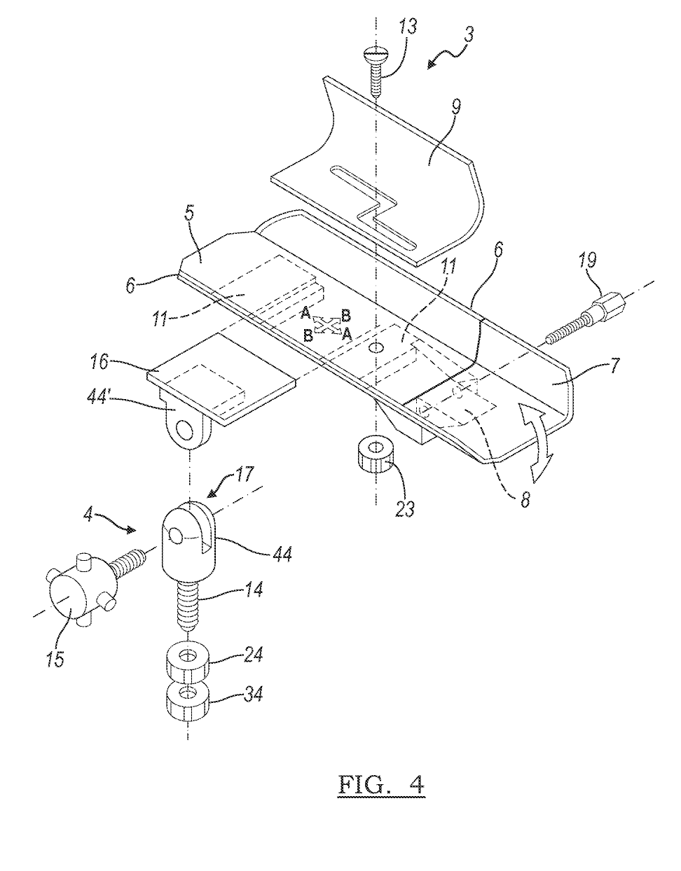

Referring also to FIGS. 2 and 4, the positioning device 1 includes a support element 3 that maintains the forearm in the required position during percutaneous interventions. In some arrangements, the positioning device 1 also includes braces to link a forearm support element 3 to the base member 2. The support element 3 includes an ergonomic shaped forearm support member 5. The spatial orientation of the support element 3, relative to the base member 2, is adjustable. Further, an oblong spacer element 4, is positioned substantially perpendicular to the base member 2 for spacing the support element 3 from the base member 2.

In various arrangements, the spacer element 4 has a joint portion which divides the spacer element 4 in two parts or components that provide relative movement between the two parts. In particular arrangements, the joint is a fork joint 17. As shown in FIG. 4, the joint 17 allows the insertion of a ring shaped element 44′ into a fork shaped element 44. The ring shape element 44′ and the forked shaped element 44 has holes to allow the insertion of a joint locking pin 15. Therefore, the joint 17 allows relative rotation of the two parts of the spacer element 4 about the axis of the locking pin 15. In certain arrangements, the locking pin 15 has a knob shape and that is inserted and threaded through the forked shaped element 44 and the ring shaped element 44′ for locking the relative rotation between the two elements 44′ and 44. In various arrangements, the spacer element 4 allows more than two degrees of movement between the components of the spacer element.

For example, the spacer element 4 has a threaded end 14 connected to the base member 2 at a receiving seat, for example a hole, provided on the base member 2 as described below. The threaded connection between the spacer element 4 and base member 2 is tightened by one or more ring nuts 34. Advantageously, the threaded connection allows the adjustment of the vertical distance between the support element 3 and the base member 2 employing different degrees of tightening of the threaded end 14 into the seat or hole of the base member 2. The threaded connection also allows a rotation of an arm support member 5 in a desired direction.

In various arrangements, an adjusting ring nut 24 connected to the treaded end 14 is employed to adjust the distance between the support element 3 and the base member 2. As shown, the spacer element 4 has a ring shaped end connected with a plate 16 that supports the arm support member 5. Various configurations of the positioning device 1 may have a telescopic spacer element to adjust the height of the support element 3 relative to the base member 2.

Guide elements 11 may be positioned in the lower portion of the arm support member 5 to allow relative sliding motion of the arm support member 5 with respect to the plate 16. As such, the arm support member 5 is allowed to slide back and forth along the guides' axis with respect to the operating table to adjust the position of the support member 5 over the operating table to accommodate the patient's body characteristics. Specifically, as shown in FIG. 4, the guides elements 11 are positioned in the B-B direction, substantially orthogonal to the A-A main direction of the support member 5. The guide elements 11 can also include or act as one or more brake elements that block relative sliding motion of the support member 5 with respect to the support plate 16.

The support member 5 includes two containment flaps 6 shaped to limit unwanted lateral movements of the patient arm. Moreover, the support member 5 includes a recliner part 7 that supports and maintains the patient's wrist in a desired extended position, for both right and left radial access.

A hinge member 8 is positioned on the inferior portion of the support member 5 to connect the support member 5 to the recliner part 7. The hinge 8 allows the recliner part 7 to recline with respect to the support member 5. A pin 19 locks the hinge member 8 so that the recliner part 7 is reclined to a desired position with respect the support member 5.

The support element 3 includes a divider 9 that is positioned or that can be positioned on the upper regions of the support element 3. The dividing element 9 is configured to adjust the width of the support member 5 according to the patient's arm size. The divider 9 can have an L shape and that is connected to the support member 5 with a pin 13 that extend through receiving seats in the support member 5 and the dividing element 9.

More specifically, the divider 9 has a step shaped seat which allows the translation of the dividing element 9 in the A-A direction of the main development of support member 5 as well in B-B direction. In other arrangements, an ergonomic shaped cushion is connected to the divider 9 to improve the patient's comfort in maintaining the appropriated arm position. A locking element, such as a nut 23, is attached to the pin 13 to secure the divider 9 in the desired position according to patient's arm size.

In use, the base member 2 is configured to be positioned under a supine patient, for example, between the operating table and a mattress supporting the patient.

As shown in FIGS. 2 and 3, the base member 2 can be configured to support one (FIG. 2) or two (FIG. 3) positioning devices 1 and 1′.

The base member 2 may include a slot shaped seat 50 that receives the threaded end 14 of the spacer element 4. The slot shape of the seat 50 allows a greater freedom in choosing the position where to lock the support 3 to the base member 2 according to patient and operator's needs.

In particular arrangements, the base member 2 includes two sliding surfaces 2′ and 2″: one surface 2′ to support the positioning device 1′ and the other surface 2″ to support the positioning device 1″, as shown in FIG. 3. The sliding surfaces 2′ and 2″ can slide relative to each other as indicated by the double arrow 90.

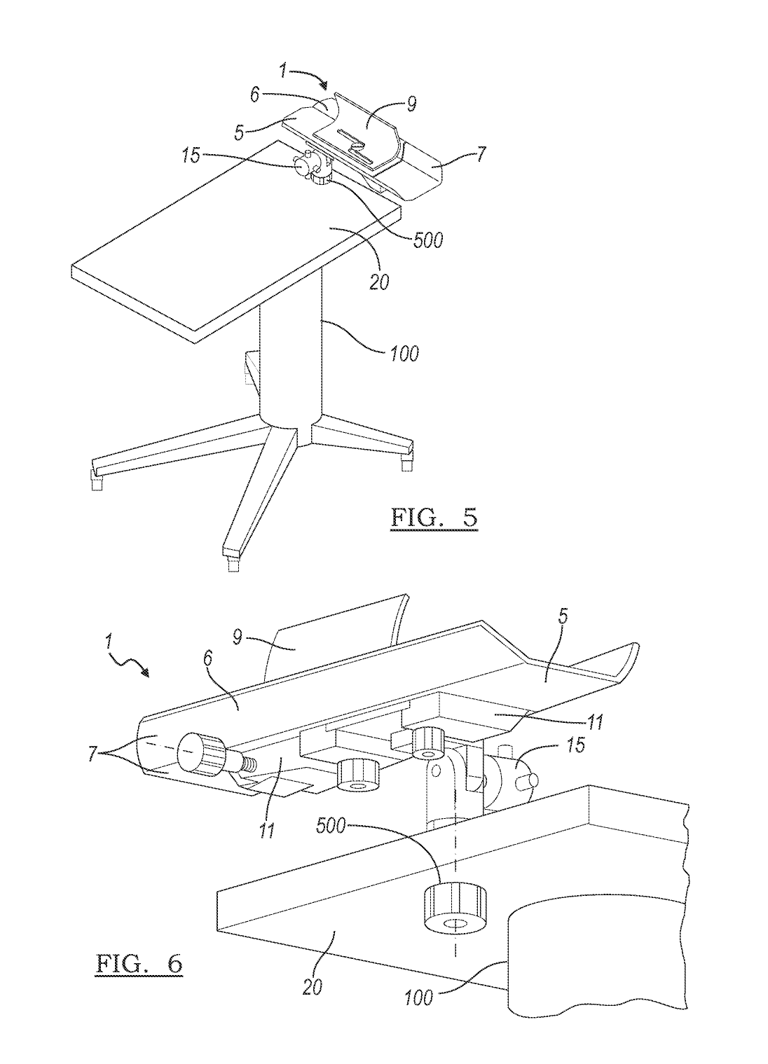

In yet another arrangement, as shown in FIGS. 5 and 6, the positioning device 1 is secured at a connector 500 to a base member 20 that is supported by a movable carriage 100.

The use of the movable carriage 100 allows supporting the arm in an abducted position during the vascular access procedure while offering at the same time a support surface for the devices to be used for the vascular access. Once the access is performed the arm is re-positioned on the positioning device 1 beside the body of the patient on the operating table.

The movable carriage 100 can be useful also outside the interventional suites. The movable carriage 100 can easily and quickly be moved to different environments, such as, for example, intensive care units, operating rooms or any other type of suitable environment.

The positioning device 1 can be manufactured with plastic materials with appropriated strength, lightness and radiolucency or any other suitable material.

The aforementioned positioning devices allow positioning the support element 3 in multiple space directions to provide the flexibility needed to fit different patient body sizes. Moreover, adjustment of the positioning device 1 can be performed at any time during the procedure to comply with the patient's, as well physician's, needs. The device is designed to allow a quick set up with any interventional operating table.

The positioning device 1 may include various components supplied as an assembly kit to be assembled into the positioning device.

Various components of the positioning device 1 can be constructed with a radiolucent material to allow the free transmission of the X-rays through the patient's arm during the interventional procedure. Moreover, the use of the positioning device 1 reduces radiation exposure of the physician since the position of the patient's arm beside his/her body allows the physician to stand behind properly positioned X-ray shields.

The description of the invention is merely exemplary in nature and variations that do not depart from the gist of the invention are intended to be within the scope of the invention. Such variations are not to be regarded as a departure from the spirit and scope of the invention.

What is claimed is:

1. A device to position and support an arm of a patient on a surface of a base member with an orientation to allow the execution of vascular access during a percutaneous interventional procedure, the device comprising:
a support element having a support member for the arm, the element being shaped to hold the arm in the desired position during the procedure; and
a spacer element that connects the support element to the base member, the spacer element including an adjustment mechanism that adjusts the relative position and orientation of the support element with respect to the base member.

2. The device of claim 1 wherein the spacer element is an oblong spacer element positioned substantially perpendicular to the base member.

3. The device of claim 1 wherein the spacer element has a joint portion that allows relative rotation of a first portion of the spacer element with respect to a second portion of the spacer element.

4. The device of claim 3 wherein the adjustment mechanism includes a locking pin with a knob-shaped end that locks the relative rotation of the first portion of the spacer element with respect to the second portion of the spacer element.

5. The device of claim 1 wherein the spacer element connects to the base member at a receiving seat provided on the base member.

6. The device of claim 5 wherein the spacer element has a threaded end that couples with the receiving seat on the base member.

7. The device of claim 6 wherein the seat is shaped as a slot.

8. The device of claim 6 wherein the adjustment mechanism includes an adjusting nut that couples to the threaded end to adjust the spacing of the support element with respect to the base member.

9. The device of claim 1 wherein the spacer element has a support plate that supports the support member.

10. The device of claim 1 wherein the spacer element includes guide elements positioned at a lower surface of the support member to allow relative sliding motion of the support member with respect to the support plate.

11. The device of claim 10 wherein the guide elements extend along a direction (B-B) substantially perpendicular to a main direction (A-A) of the support member.

12. The device of claim 10 wherein the adjustment mechanism includes one or more brake elements that block the relative sliding motion the support member.

13. The device of claim 1 wherein the support member has two flaps to contain lateral movements of the arm.

14. The device of claim 1 wherein the support member includes a recliner portion.

15. The device of claim 14 wherein the spacer element includes a hinge member positioned at a lower surface of the support member to facilitate tilting of the recliner portion.

16. The device of claim 15 wherein the adjustment mechanism includes a pin that couples to the hinge member to lock the recliner portion at a desired position.

17. The device of claim 1 further comprising a divider positioned at an upper surface of the support element to adjust the width of the support member.

18. The device of claim 17 wherein the spacer element includes a pin that couples the divider to the support element.

19. The device of claim 18 wherein the pin is a locking element that that couples the divider to the support element in a desired position.

20. The device of claim 18 wherein the divider has a seat in which the pin is inserted, the seat having a step shape.

21. The device of claim 1 wherein the base member is configured to be positioned under the back of the patient in a supine position.

22. The device of claim 1 further comprising a movable carriage that supports the base member.

23. The device of claim 1 wherein the support element and the spacer element are provided as an assembly kit.
